(19) United States
(12) Patent Application Publication
(10) Pub. No.: US 2008/0315942 A1
(43) Pub. Date: Dec. 25, 2008

(54) Vt Stabilization of TFT's In OLED Backplanes

(75) Inventor: Thomas Peter Brody, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: ADVANTECH GLOBAL, LTD, Tortola (VG)

(21) Appl. No.: 12/043,174

(22) Filed: Mar. 6, 2008

Related U.S. Application Data
(63) Continuation-in-part of application No. 11/820,659, filed on Jun. 20, 2007.

(51) Int. Cl. G05F 3/16

(52) U.S. Cl. 327/543

(57) ABSTRACT

In a method of reducing or undoing progressive threshold shift in a thin-film-transistor (TFT) circuit, first and second voltages applied to source and gate terminals of a first transistor cause the first transistor to conduct and apply the first voltage to the gate terminal of the second transistor. The first voltage applied to the gate terminal of the second transistor coacts with a reference voltage coupled to the source terminal of the second transistor via an LED element to cause the second transistor to not conduct whereupon the LED element does not receive electrical power. After a first predetermined period of time sufficient to reduce or undo a progressive threshold shift in the second transistor, the application of the first voltage to the gate terminal of the second transistor is terminated.

### CROSS REFERENCE TO RELATED APPLICATION

This application is a continuation-in-part of co-pending U.S. patent application Ser. No. 11/820,659, filed Jun. 20, 2007, the contents of which are incorporated herein by reference.

### BACKGROUND OF THE INVENTION

1. Field of the Invention

The present invention relates to reducing or undoing progressive threshold shift in a thin-film-transistor (TFT).

2. Description of Related Art

Organic light emitting diode (OLED) backplanes used in display devices have pixels made from thin-film-transistors (TFTs) formed on the backplane. These TFTs are often made from cadmium selenide (CdSe), amorphous silicon, polycrystalline silicon, or tellurium (Te). Each pixel also includes one or more LED elements formed of a light emitting material. In practice, each LED element is driven by at least one TFT which is operative for selectively supplying or withholding electrical power to or from the LED element to cause the LED element to selectively emit or not emit light.

It has been observed that TFTs suffer from a phenomena called progressive threshold shift which is caused by the injection of energetic electrons into the gate insulator of the TFTs and the retention of these electrons in the gate insulator. One problem with progressive threshold shift is that for a given amount of input bias to the TFT, the amount of light output by the corresponding LED element decreases.

### SUMMARY OF THE INVENTION

A method is disclosed of controlling a thin-film-transistor (TFT) circuit to reduce or undo a progressive threshold shift in one or more TFTs thereof. The TFT circuit includes a first transistor having its drain terminal connected to the gate terminal of a second transistor that has its drain and source terminals connected to a supply voltage (Vcc) and a terminal of an LED element, the other terminal of which is connected to a reference voltage. The method includes (a) applying to the source terminal of the first transistor a first voltage; (b) applying to the gate terminal of the first transistor a second voltage, said first and second applied voltages causing the first transistor to conduct and apply the first voltage to the gate terminal of the second transistor via the source and drain terminals of the first transistor, said first voltage applied to the gate terminal of the second transistor coacting with the reference voltage coupled to the source terminal of the second transistor via the LED element to cause the second transistor to not conduct, whereupon Vcc is not coupled to the LED element; and (c) after a first predetermined period of time, terminating the application of the first voltage to the gate terminal of the second transistor.

The method can further include applying between the gate and source terminals of the first transistor a voltage that causes the first transistor to not conduct, but which causes at least a partial reversal of a progressive threshold shift in the first transistor.

The method of claim 1, further including (d) applying to the source terminal of the first transistor a third voltage; (e) applying to the gate terminal of the first transistor a fourth voltage, said third and fourth applied voltages causing the first transistor to conduct and apply the third voltage to the gate terminal of the second transistor via the source and drain terminals of the first transistor, said third voltage applied to the gate terminal of the second transistor coacting with the reference voltage coupled to the source terminal of the second transistor via the LED element to cause the second transistor to conduct, whereupon Vcc is coupled to the LED element via the drain and source terminals of the second transistor; and (f) after a second predetermined period of time, terminating the application of the third voltage to the gate terminal of the second transistor.

The reference voltage can be ground potential. When the first and second transistors are n-channel transistors, the first voltage can be a negative voltage of sufficient extent to cause at least a partial reversal of a progressive threshold shift in the second transistor and the third voltage can be a positive voltage of sufficient extent to cause the second transistor to conduct.

When the first and second transistors are p-channel transistors, the first voltage can be a positive voltage of sufficient extent to cause at least a partial reversal of a progressive threshold shift in the second transistor and the third voltage can be a negative voltage of sufficient extent to cause the second transistor to conduct.

### BRIEF DESCRIPTION OF THE DRAWINGS

FIG. 1A is a diagrammatic illustration of a shadow mask deposition system for forming pixel structures of a high resolution active matrix backplane;

FIG. 1B is an enlarged view of a single deposition vacuum vessel of the shadow mask deposition system of FIG. 1A; and

FIG. 2 is a circuit schematic of a 3×3 array of sub-pixels of an active matrix backplane that can be formed by the shadow mask deposition system illustrated in FIG. 1A, wherein a 2×2 array of said 3×3 array defines a pixel of said active matrix backplane.

### DETAILED DESCRIPTION OF THE INVENTION

The present invention will be described with reference to the accompanying figures where like reference numbers correspond to like elements.

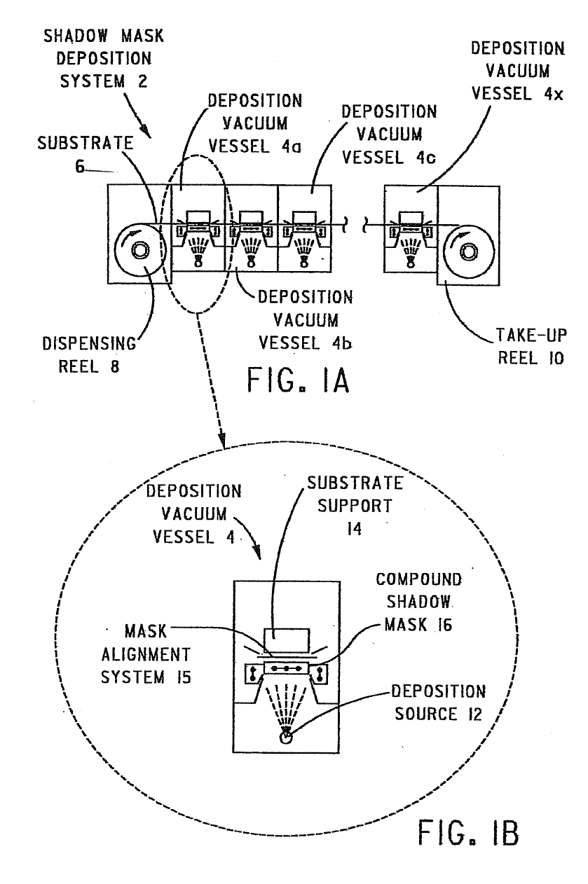

With reference to FIGS. 1A and 1B, a shadow mask deposition system 2 for forming an electronic device, such as, without limitation, a high resolution active matrix light emitting diode (LED) display, includes a plurality of serially arranged deposition vacuum vessels 4 (e.g., deposition vacuum vessels 4a-4x). The number and arrangement of deposition vacuum vessels 4 is dependent on the number of deposition events required for any given product to be formed therewith.

In use of shadow mask deposition system 2, a flexible substrate 6 translates through the serially arranged deposition vacuum vessels 4 by means of a reel-to-reel mechanism that includes a dispensing reel 8 and a take-up reel 10.

Each deposition vacuum vessel includes a deposition source 12, a substrate support 14, a mask alignment system 15 and a compound shadow mask 16. For example, deposition vacuum vessel 4a includes deposition source 12a, substrate support 14a, mask alignment system 15a and compound shadow mask 16a; deposition vacuum vessel 4b includes deposition source 12b, substrate support 14b, mask alignment system 15b and compound shadow mask 16b; and so forth for any number of deposition vacuum vessels 4.

Each deposition source 12 is charged with a desired material to be deposited onto substrate 6 through one or more openings in the corresponding compound shadow mask 16 which is held in intimate contact with the portion of substrate 6 in the corresponding deposition vacuum vessel 4 during a deposition event.

Each compound shadow mask 16 of shadow mask deposition system 2 includes one or more openings. The opening(s) in each compound shadow mask 16 correspond(s) to a desired pattern of material to be deposited on substrate 6 from a corresponding deposition source 12 in a corresponding deposition vacuum vessel 4 as substrate 6 translates through shadow mask deposition system 2.

Each compound shadow mask 16 is formed of, for example, nickel, chromium, steel, copper, Kovar® or Invar®, and has a thickness desirably between 20 and 200 microns, and more desirably between 20 and 50 microns. Kovar® and Invar® can be obtained from, for example, ESPICorp Inc. of Ashland, Oreg. In the United States, Kovar® is a registered trademark, Registration No. 337,962, currently owned by CRS Holdings, Inc. of Wilmington, Del., and Invar® is a registered trademark, Registration No. 63,970, currently owned by Imphy S.A. Corporation of France.

Those skilled in the art will appreciate that shadow mask deposition system 2 may include additional stages (not shown), such as an anneal stage, a test stage, one or more cleaning stages, a cut and mount stage, and the like, as are well-known. In addition, the number, purpose and arrangement of deposition vacuum vessels 4 can be modified by one of ordinary skill in the art as needed for depositing one or more materials required for a particular application. An exemplary shadow mask deposition system and method of use thereof is disclosed in U.S. patent application Ser. No. 10/255,972, filed Sep. 26, 2002, and entitled “Active Matrix Backplane For Controlling Controlled Elements And Method Of Manufacture Thereof”, which is incorporated herein by reference.

Deposition vacuum vessels 4 can be utilized for depositing materials on substrate 6 to form one or more electronic elements of the electronic device on substrate 6. Each electronic element may be, for example, a thin film transistor (TFT), a memory element, a capacitor etc., or, a combination of one or more of said elements to form a higher level electronic element, such as, without limitation, a sub-pixel or a pixel of the electronic device. In accordance with the present invention, a multi-layer circuit can be formed solely by successive depositions of materials on substrate 6 via successive deposition events in deposition vacuum vessels 4.

Each deposition vacuum vessel 4 is connected to a source of vacuum (not shown) which is operative for establishing a suitable vacuum therein in order to enable a charge of the material disposed in the corresponding deposition source 12 to be deposited on substrate 6 in a manner known in the art, e.g., sputtering or vapor phase deposition, through the one or more openings in the corresponding compound shadow mask 16.

Herein, substrate 6 is described as a continuous flexible sheet which is dispensed from dispensing reel 8, which is disposed in a pre-load vacuum vessel, into the deposition vacuum vessels 4. However, this is not to be construed as limiting the invention since shadow mask deposition system 2 can be configured to continuously process a plurality of standalone or individual substrates. Each deposition vacuum vessel 4 can include supports or guides that avoid the sagging of substrate 6 as it advances therethrough.

In operation of shadow mask deposition system 2, the material disposed in each deposition source 12 is deposited on the portion of substrate 6 in the corresponding deposition vacuum vessel 4 through one or more openings in the corresponding compound shadow mask 16 in the presence of a suitable vacuum as said portion of substrate 6 is advanced through the deposition vacuum vessel 4, whereupon plural, progressive patterns are formed on substrate 6. More specifically, substrate 6 has plural portions, each of which is positioned for a predetermined time interval in each deposition vacuum vessel 4. During this predetermined time interval, material is deposited from the corresponding deposition source 12 onto the portion of substrate 6 that is positioned in the corresponding deposition vacuum vessel 4. After this predetermined time interval, substrate 6 is step advanced so that the portion of substrate 6 is advanced to the next vacuum vessel in series for additional processing, as applicable. This step advancement continues until each portion of substrate 6 has passed through all deposition vacuum vessels 4. Thereafter, each portion of substrate 6 exiting the final deposition vacuum vessel 4 in the series is received on take-up reel 10, which is positioned in a storage vacuum vessel (not shown). Alternatively, each portion of substrate 6 exiting shadow mask deposition system 2 is separated from the remainder of substrate 6 by a cutter (not shown).

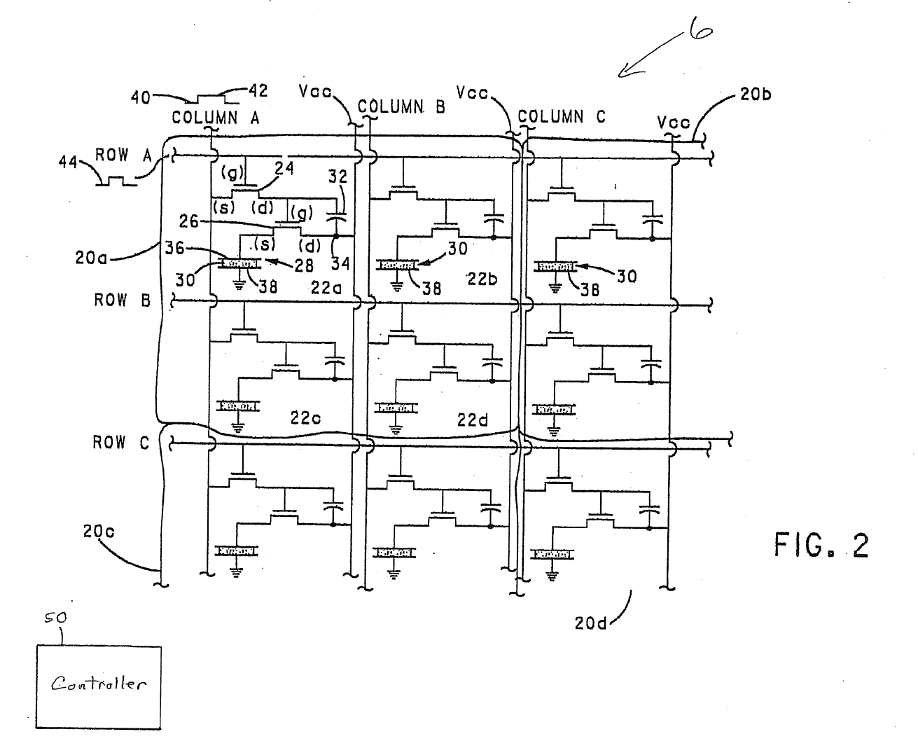

With reference to FIG. 2, an exemplary LED pixel 20a that can be formed on a standalone substrate 6 via shadow mask deposition system 2 comprises a 2×2 arrangement of sub-pixels 22, e.g., sub-pixels 22a-22d. Sub-pixels 22a, 22b, 22c and 22d can be a red sub-pixel, a first green sub-pixel, a second green sub-pixel and a blue sub-pixel, respectively. Alternatively, sub-pixels 22a, 22b, 22c and 22d can be a red sub-pixel, a first blue sub-pixel, a second blue sub-pixel and a green sub-pixel, respectively. Since LED pixel 20a is representative of one of several of identical pixels arranged in any user defined array configuration for forming a complete active matrix LED device, the description of LED pixel 20a, including the color of each sub-pixel 22, is not to be construed as limiting the invention. In FIG. 2, sub-pixels of adjacent pixels 20b, 20c and 20d are shown for illustration purposes.

Sub-pixels 22a and 22b are addressed via a pulse signal applied on a Row A bus and via voltage levels applied on a Column A bus and a Column B bus, respectively. Sub-pixels 22c and 22d are addressed via a pulse signal applied on a Row B bus and via voltage levels applied on the Column A and the Column B bus, respectively. Each bus can also be formed on a standalone substrate 6 via shadow mask deposition system 2.

In the illustrated embodiment, each sub-pixel 22 includes cascade connected transistors 24 and 26, such as, without limitation, thin film transistors (TFTs); an LED element 28 formed of light emitting material 30 (such as, without limitation, organic light emitting material) sandwiched between two electrodes 36 and 38; and a capacitor 32 which serves as a voltage storage element. In an exemplary, non-limiting embodiment, transistors 24 and 26, LED element 28 and capacitor 32 of each sub-pixel 22 are interconnected to each other in a manner illustrated in FIG. 2. In addition, for each sub-pixel 22, a control or gate terminal of transistor 24 is electrically connected to a suitable row bus, a node 34 formed by the connection of the drain terminal of transistor 26 to one terminal of capacitor 32 is connected to a power bus (Vcc), and the source terminal of transistor 24 is connected to a suitable column bus.

To activate each LED element 28 when a suitable voltage is applied to the corresponding power bus Vcc, the voltage applied to the corresponding column bus connected to the source terminal of transistor 24 is changed from a first voltage 40 to a second voltage 42. During application of second voltage 42, a pulse signal 44 is applied to the row bus connected to the gate terminal of transistor 24. Pulse signal 44 causes transistors 24 and 26 to conduct, whereupon, subject to the voltage drop across transistor 26, the voltage of power bus Vcc is applied to one terminal of LED element 28. Since the other terminal of LED element 28 is connected to a different potential, e.g., ground potential, the application of the voltage applied to power bus Vcc to LED element 28 causes LED element 28 to illuminate. During application of pulse signal 44, capacitor 32 charges to the difference between second voltage 42 and the voltage on power bus Vcc, minus any voltage drop across transistor 24.

Upon termination of pulse signal 44, capacitor 32 retains the voltage stored thereon and impresses this voltage on the gate terminal of transistor 26, whereupon LED element 28 is held in an active, illuminating state in the absence of pulse signal 44.

LED element 28 is turned off when pulse signal 44 is applied in the presence of first voltage 40 on the corresponding column bus. More specifically, applying pulse signal 44 to the gate terminal of transistor 24 when first voltage 40 is applied to the source terminal of transistor 24 causes transistor 24 to turn on, whereupon capacitor 32 discharges through transistor 24 thereby turning off transistor 26 and deactivating LED element 28. Upon termination of pulse signal 44, capacitor 34 is charged to approximately voltage 40, whereupon transistor 26 is held in its off state and LED element 28 is held in its inactive state even after pulse signal 44 is terminated.

In a like manner, each LED element 28 of each sub-pixel 22 of each pixel 20 can be turned on and off in response to the application of a pulse signal 44 on an appropriate row bus when second voltage 42 and first voltage 40, respectively, are applied to the appropriate column bus in the presence of a suitable voltage applied via the appropriate power bus Vcc.

Desirably, transistors 24 and 26 are TFTs formed from cadmium selenide (CdSe), amorphous silicon, polycrystalline silicon, or tellurium (Te). Hereinafter, for the purpose of description, it will be assumed that transistors 24 and 26 are n-channel transistors. However, this is not to be construed as limiting the invention since it is envisioned that transistors 24 and 26 can be p-channel transistors and that the voltages described hereinafter that can be applied to transistors 24 and 26 via the corresponding row and column buses can be selected as necessary to account for transistors 24 and 26 being either p-channel transistors or n-channel transistors.

In one exemplary, non-limiting embodiment, in normal operation of each sub-pixel 22, the corresponding transistor 24 is turned-on by applying a first suitable positive DC voltage, e.g., without limitation, +20 volts DC, to the gate (g) terminal thereof and a second suitable positive DC voltage, e.g., without limitation, +10 volts DC, to the source(s) terminal thereof, whereupon VGS for transistor 24 is a positive DC voltage, in this example about +10 volts DC. With transistor 24 turned-on by the application of these voltages, the DC voltage applied to the gate (g) terminal of transistor 26 will be the DC voltage applied to the source (s) terminal of transistor 24 minus any voltage drop across the source (s) and drain (d) terminals of transistor 24. Since the source terminal of transistor 26 is biased to ground potential via the light emitting material 30 of LED element 28, VGS for transistor 26 will be about +10 volts DC and transistor 26 will also be turned-on.

It has been observed that in normal operation, TFTs, such as transistors 24 and 26, suffer from a progressive threshold shift due to the injection of energetic charges (e.g., electrons) into traps in the gate insulators thereof. Nonvolatile semiconductor memory devices, such as flash memories, use such traps for storage. However, imperfect trapping and undesirable retention of such injected charge (electrons) in transistor 24 and/or transistor 26 may cause undesirable progressive threshold shift(s) that adversely affect(s) the operation thereof, especially transistor 26 which, in operation, carries more current than transistor 24. For example, in response to an increasing progressive threshold shift for a given value of VGS for each transistor 24 and 26, a decreasing source to drain current (ISD) or drain to source current (IDS) is observed.

To overcome this undesirable progressive threshold shift in each transistor 26, a first suitable (relatively large) negative DC voltage (e.g., without limitation, no less than about −15 volts DC) can occasionally or periodically be applied to the gate (g) terminal of transistor 26. For the purpose of the following description, hereinafter the first negative DC voltage applied to the gate (g) terminal of transistor 26 will be generally described as being −15 volts DC. However, this is not to be construed as limiting the invention since it is envisioned that any suitable and/or desirable negative DC voltage, especially a voltage more negative than −15 volts DC, that reduces or undoes the progressive threshold shift in transistor 26 can be applied to the gate terminal thereof.

To accomplish the removal of some or all undesirably trapped electrons in each transistor 26 and, hence, the reduction or undoing of the progressive threshold shift in said transistor 26, the first negative DC voltage, e.g., without limitation, −15 volts DC, is applied to the column bus that services the source (s) terminal of the corresponding transistor 24. During application of this first negative DC voltage to the column bus that services the source (s) terminal of the corresponding transistor 24, a second suitable negative DC voltage, e.g., without limitation, −5 volts DC, is applied, e.g., in the form of pulse signal 44, to the row bus that services the gate (g) terminal of said transistor 24, whereupon VGs for transistor 24 is +10 volts DC, which is the same VGs that is used to turn-on transistor 24 in normal operation.

With transistor 24 turned-on by the application these negative voltages, the DC voltage applied to the gate (g) terminal of transistor 26 will be the first negative DC voltage that is applied to the source (s) terminal of transistor 24 (in this example −15 volts DC) minus any voltage drop across the source (s) and drain (d) terminals of transistor 24. Since the source terminal of transistor 26 is biased to a ground (or reference) potential via the light emitting material 30 of LED element 28, VGS for transistor 26 will be about −15 volts DC and transistor 26 will be turned-off. Application of the first negative DC voltage to the gate terminal of transistor 26 in this manner reduces or undoes the imperfect trapping and retention of electrons (i.e., expels the trapped electrons) in transistor 26 and, hence, the complete or partial removal of the progressive threshold shift in transistor 26.

To accomplish the removal of undesirably trapped electrons in each transistor 24 and, hence, the reduction or undoing of the progressive threshold shift in said transistor 24, a third suitable negative DC voltage is applied to the gate (g) terminal of transistor 24 that causes the VGS of said transistor 24 to equal, for example, without limitation, −15 volts DC or a DC voltage more negative than −15 volts DC. For example, the third negative DC voltage, e.g., without limitation, −15 volts DC, can be applied to the gate (g) terminal of transistor 24 via the corresponding row bus while a ground (or reference) potential can be connected to the source (s) terminal of transistor 24 via the corresponding column bus, whereupon the VGS of transistor 24 is set to −15 volts DC and transistor 24 is turned-off. Application of the third negative DC voltage, e.g., without limitation, −15 volts DC, and the ground potential to the respective gate (g) and source (s) terminals of transistor 24 in this manner reduces or undoes the imperfect trapping and retention of electrons (i.e., expels the trapped electrons) in transistor 24 and, hence, the complete or partial removal of the progressive threshold shift in transistor 24.

The first negative DC voltage, e.g., −15 volts DC, applied to the gate (g) terminal of a single transistor 26 described above can be applied to the gate terminal of each transistor 26 of each sub-pixel 22 in any suitable and/or desirable sequence. For example, each transistor 26, one at a time, can have the first negative DC voltage applied to its gate (g) terminal by the application of suitable voltages to the corresponding column and row buses that cause the corresponding transistor 24 to conduct. Also or alternatively, plural transistors 26 have the first negative DC voltage applied to their gate (g) terminals at the same time by the application of suitable voltages to the corresponding column and row buses that cause the corresponding transistors 24 to conduct. Accordingly, the above description regarding the application of the first negative DC voltage, e.g., −15 volts DC, to the gate (g) terminal of a single transistor 26 is not to be construed as limiting the invention.

Similarly, the third negative DC voltage, e.g., −15 volts DC, and reference ground applied to the respective gate (g) and source (s) terminals of a single transistor 24 described above can also or alternatively be applied to one or more transistors 24 in any suitable and/or desirable sequence, e.g., one at a time or a plurality of transistors 24 at the same time. In the circuit schematic shown in FIG. 2, each row bus is shown connected to the gate (g) terminals of a plurality of transistors 24. Accordingly, the third negative DC voltage, e.g., −15 volts DC, can be applied to the gate (g) terminals of these transistors 24 by the application of the third negative DC voltage, e.g., −15 volts DC, to said row bus. In order to promote the removal of undesirably trapped electrons in each transistor 24 in said row when the third negative DC voltage, e.g., −15 volts DC, is applied thereto, a reference ground can be connected to the source (s) terminal of each said transistor 24, one at a time or in parallel, by way of the corresponding column bus or buses. Thus, complete or partial removal of the progressive threshold shift in one or more transistors 24 at a time in each row can be accomplished. Accordingly, the above description regarding the application of the third negative DC voltage, e.g., −15 volts DC, and reference ground applied to the respective gate (g) and source (s) terminals of a single transistor 24 is not to be construed as limiting the invention.

Any suitable and/or desirable duration of the application of the third negative DC voltage and the reference voltage to the respective gate (g) and source (s) terminals of each transistor 24 and/or the application of the first negative DC voltage to the gate terminal of each transistor 26 can be selected to accomplish the desired reduction or undoing of the progressive threshold shift of the transistor. In one non-limiting embodiment where transistors 24 and 26 form the pixels of an OLED video display that may operate at a frame rate between 24 and 60 frames per second, the duration that each transistor 24 has the third negative DC voltage and the reference voltage applied to the respective gate (g) and source (s) terminals thereof and/or the duration that each transistor 26 has the first negative DC voltage applied to the gate (g) terminal thereof can be either: a whole or partial frame period; 1/n period of time where n=the line (row or column) address time period; a first line in one frame, a second line in another frame, and so forth in any order; or multiple consecutive or nonconsecutive frames. The third negative DC voltage and the reference voltage applied to the gate (g) and source (s) terminals of each transistor 24 and/or the first negative DC voltage applied to the gate (g) terminal of each transistor 26 of an OLED display can be applied during initialization or start-up of the display and/or occasionally/periodically in any suitable and/or desirable manner during operation of the display to reduce or avoid the occurrence of the progressive threshold shift therein.

It is envisioned that the need to undo the progressive threshold shift in each transistor 26 may be different than the need to undo the progressive threshold shift in each transistor 24. Accordingly, it is envisioned that different durations and/or sequences of the application of one or more negative voltages to the gate terminal of each transistor 24 and/or 26 may be used. For example, without limitation, each instance of transistor 26 may benefit from the application of the first negative DC voltage to its gate (g) terminal 10, 100, 1000 or more times more often than application of the third negative DC voltage and the reference voltage to the gate (g) and source (s) terminals of each transistor 24. However, this is not to be construed as limiting the invention since it is envisioned that each transistor 24 may not experience progressive threshold shift and, therefore, may not require the application of the third negative DC voltage and the reference voltage to the gate (g) and source (s) terminals thereof. In this case, the first negative DC voltage will only be applied to the gate terminals of transistors 26 at suitable and/or desirable intervals and sequences in the manner described above.

The decision to undo the progressive threshold shift in transistor 24 and/or transistor 26 of each sub-pixel 22 can be based on the amount of use the sub-pixel 22 experiences in use as recorded by a controller 50. Thus, sub-pixels 22 that experience more use can have their transistor(s) 24 and/or 26 biased more often in the manner described above to undo any progressive threshold shifts the transistor(s) may be experiencing than the transistors of sub-pixels that experience less use.

Controller 50 is desirably provided and coupled to each row and column bus of substrate 6 for controlling the voltages applied to each bus in the manner described above for normal operation of each sub-pixel 22 and for undoing the progressive threshold shift in transistor 24 and/or transistor 26 of the sub-pixel 22. In normal operation, controller 50 can be operative for converting an incoming video data stream (not shown) into corresponding voltages that are applied to one or more buses of substrate 6 in the manner described above to produce a video image or a sequence of video images corresponding to the video data stream. During initialization or start-up of the display and/or occasionally/periodically during normal operation thereof, controller 50 can apply suitable voltages to row and column buses of substrate 6 in any suitable and/or desirable manner or sequence to reduce or avoid the occurrence of the progressive threshold shift in the transistor(s) of one ore more sub-pixels 22 of substrate 6. Controller 50 can be mounted on substrate 6 or can be remote from substrate 6 and coupled to the substrate 6 in any suitable and/or desirable manner.

The invention has been described with reference to the preferred embodiment. Obvious modifications and alterations will occur to others upon reading and understanding the preceding detailed description. For example, when transistors 24 and 26 are p-channel transistors, a suitably large positive DC voltage (e.g., without limitation, about +15 volts DC) can occasionally or periodically be applied to the gate terminal of transistor 26 to reduce or undo any progressive threshold shift therein without causing transistor 26 to conduct. Similarly, appropriate voltages to be applied to the gate and source terminals of the corresponding p-channel transistor 24 can be selected in any suitable and/or desirable manner to realize the application of a positive DC voltage of suitable value to the gate of p-channel transistor 26.

Moreover, the first, second and third negative DC voltages described above are not to be construed as limiting the invention in any way since it is envisioned that any suitable negative DC voltage, combination of negative DC voltages and/or reference potential(s) can be selected by one of ordinary skill in the art. It is intended that the invention be construed as including all such modifications and alterations insofar as they come within the scope of the appended claims or the equivalents thereof.

The invention claimed is:

1. A method of controlling a thin-film-transistor circuit comprised of a first transistor having its drain terminal connected to the gate terminal of a second transistor that has its drain and source terminals connected to Vcc and a terminal of an LED element, the other terminal of which is connected to a reference voltage, the method comprising:
(a) applying to the source terminal of the first transistor a first voltage;
(b) applying to the gate terminal of the first transistor a second voltage, said first and second applied voltages causing the first transistor to conduct and apply the first voltage to the gate terminal of the second transistor via the source and drain terminals of the first transistor, said first voltage applied to the gate terminal of the second transistor coacting with the reference voltage coupled to the source terminal of the second transistor via the LED element to cause the second transistor to not conduct, whereupon Vcc is not coupled to the LED element; and
(c) after a first predetermined period of time, terminating the application of the first voltage to the gate terminal of the second transistor.

2. The method of claim 1, further including:
applying between the gate and source terminals of the first transistor a voltage that causes the first transistor to not conduct, but which causes at least a partial reversal of a progressive threshold shift in the first transistor.

3. The method of claim 1, further including:
(d) applying to the source terminal of the first transistor a third voltage;
(e) applying to the gate terminal of the first transistor a fourth voltage, said third and fourth applied voltages causing the first transistor to conduct and apply the third voltage to the gate terminal of the second transistor via the source and drain terminals of the first transistor, said third voltage applied to the gate terminal of the second transistor coacting with the reference voltage coupled to the source terminal of the second transistor via the LED element to cause the second transistor to conduct, whereupon Vcc is coupled to the LED element via the drain and source terminals of the second transistor; and
(f) after a second predetermined period of time, terminating the application of the third voltage to the gate terminal of the second transistor.

4. The method of claim 3, wherein:
the reference voltage is ground potential; and
when the first and second transistors are n-channel transistors, the first voltage is a negative voltage of sufficient extent to cause at least a partial reversal of a progressive threshold shift in the second transistor and the third voltage is a positive voltage of sufficient extent to cause the second transistor to conduct.

5. The method of claim 3, wherein:
the reference voltage is ground potential; and
when the first and second transistors are p-channel transistors, the first voltage is a positive voltage of sufficient extent to cause at least a partial reversal of a progressive threshold shift in the second transistor and the third voltage is a negative voltage of sufficient extent to cause the second transistor to conduct.
